(19) United States
(12) Patent Application Publication
(10) Pub. No.: US 2004/0254821 A1
(43) Pub. Date: Dec. 16, 2004

(54) Apparatus and method for analyzing real estate information

(76) Inventor: James B. Glaser, Sharon, MA (US)

Correspondence Address: BROMBERG & SUNSTEIN LLP, 125 SUMMER STREET, BOSTON, MA, 02110-1618, US

(21) Appl. No.: 10/804,731

(22) Filed: Mar. 19, 2004

Related U.S. Application Data
(60) Provisional application No. 60/477,681, filed on Jun. 11, 2003.

(51) Int. Cl. G06F 17/60

(52) U.S. Cl. 705/7

(57) ABSTRACT

A method and apparatus analyzes real estate information relating to potential buyers and a potential seller. Potential buyers each generate a list of characteristics of real estate they may be interested in purchasing. These buyer real estate characteristics are then indexed. A seller creates at least one characteristic of real estate they may be interested in selling. The at least one seller real estate characteristic is then collected. The indexed buyer real estate characteristics are compared to the at least one seller real estate characteristic. It is determined if there is a match between at least one of the potential buyers and the potential seller, based on the comparison.

### PRIORITY

This application claims priority from provisional U.S. patent application No. 60/477,681, filed on Jun. 11, 2003, which is herein incorporated entirely by reference.

### TECHNICAL FIELD AND BACKGROUND ART

The present invention relates to the field of real estate, particularly the analysis of information related to real estate.

It is well known in the prior art for people desiring to sell their home or other real estate to provide information about the real estate to the public. This process is commonly known as “listing the real estate.” The listing attracts the attention of potential purchasers, who then contact the seller about potentially buying the real estate. The goal of the process is for the seller, through the listing, to attract the attention of a buyer who ultimately purchases the real estate.

One method of listing real estate for sale is to use the Multiple Listings Service (MLS) offered by professional real estate sales brokers. The MLS stores information about the real estate, including its location and the price the seller has set, on a computer network. A potential seller, or an agent for a potential seller, provides this information. The MLS typically includes information about many different pieces of real estate from many different potential sellers. A potential buyer, or an agent for a potential buyer, is then able to access this network and search the numerous listings for real estate they might be interested in purchasing. There are also websites, such as realtor.com, that offer services similar to those provided by the MLS on behalf of professional realtors. Despite the ease of access to potential sellers that a potential buyer has, no service offers a comparable ease of access to potential buyers for a potential seller. Instead, sellers typically must list their real estate with a large number of competitive properties in a large database, such as the MLS.

### SUMMARY OF THE INVENTION

In accordance with one aspect of the invention, a method analyzes real estate information relating to potential buyers and a potential seller. Potential buyers each generate a list of characteristics of real estate they may be interested in purchasing. These buyer real estate characteristics are then indexed. A seller creates at least one characteristic of real estate they may be interested in selling. The at least one seller real estate characteristic is then collected. The indexed buyer real estate characteristics are compared to the seller real estate characteristics. It is determined if there is a match between at least one of the potential buyers and the potential seller, based on the comparison.

In a related embodiment, to determine if there is a match, the indexed buyer real estate characteristics may be accessed. Before being accessed, the indexed buyer real estate characteristics are categorized into at least one category. The category may include location. The at least one seller real estate characteristic is also categorized into at least one category. Like categories of indexed buyer real estate characteristics are then compared with seller real estate characteristics.

In accordance with another aspect of the invention, an apparatus analyzes real estate information relating to potential buyers and a potential seller. The apparatus includes a buyer module, a seller module, a comparator, and a match module. The buyer module indexes the buyer real estate characteristics that were generated by potential buyers. The seller module collects at least one seller real estate characteristic that was generated by the potential seller. The comparator compares the indexed buyer real estate characteristics with the at least one seller real estate characteristic. The match module determines, based on the comparison, if at least one of the buyers and the seller match.

In a related embodiment, the match module may include an access module, a categorizer module, and a determiner module. The access module accesses the indexed buyer real estate characteristics, which have been categorized into at least one category. The categorizer module categorizes the at least one seller real estate characteristic into at least one category. The category may be, for example, location. The determiner module compares like categories of indexed buyer real estate characteristics with seller real estate characteristics.

In illustrative embodiments, at least one of the potential buyers may include an agent of the potential buyer. The potential seller may include an agent of the seller. In other related illustrative embodiments, the indexed buyer real estate characteristics may be stored in a computer storage device.

In still other illustrative embodiments, if a match is obtained, it is identified. This may be done by an identifier module. Further, the potential seller and a potential buyer may communicate with each other. This may be done by a communicator. The first time this communication occurs, both parties do not know the identity of the other party.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

The foregoing features of the invention will be more readily understood by reference to the following detailed description, taken with reference to the accompanying drawings, in which:

FIG. 1 schematically shows a computer system upon which illustrative embodiments of the invention may be implemented.

FIG. 2 shows a method of analyzing real estate data in accordance with illustrative embodiments of the invention.

### DETAILED DESCRIPTION OF SPECIFIC EMBODIMENTS

Illustrative embodiments of the invention analyze a database having indexed real estate information from a plurality of potential buyers to determine if the real estate needs of any of those potential buyers match those of a potential seller. To that end, various embodiments first index real estate information relating to the various different buyers. After collecting real estate information of the potential seller, various embodiments then compare the indexed information with the seller real estate information to determine if there is a match. If there is a match, then identities of the parties can be exchanged to potentially consummate a sale. Details of various embodiments are discussed below.

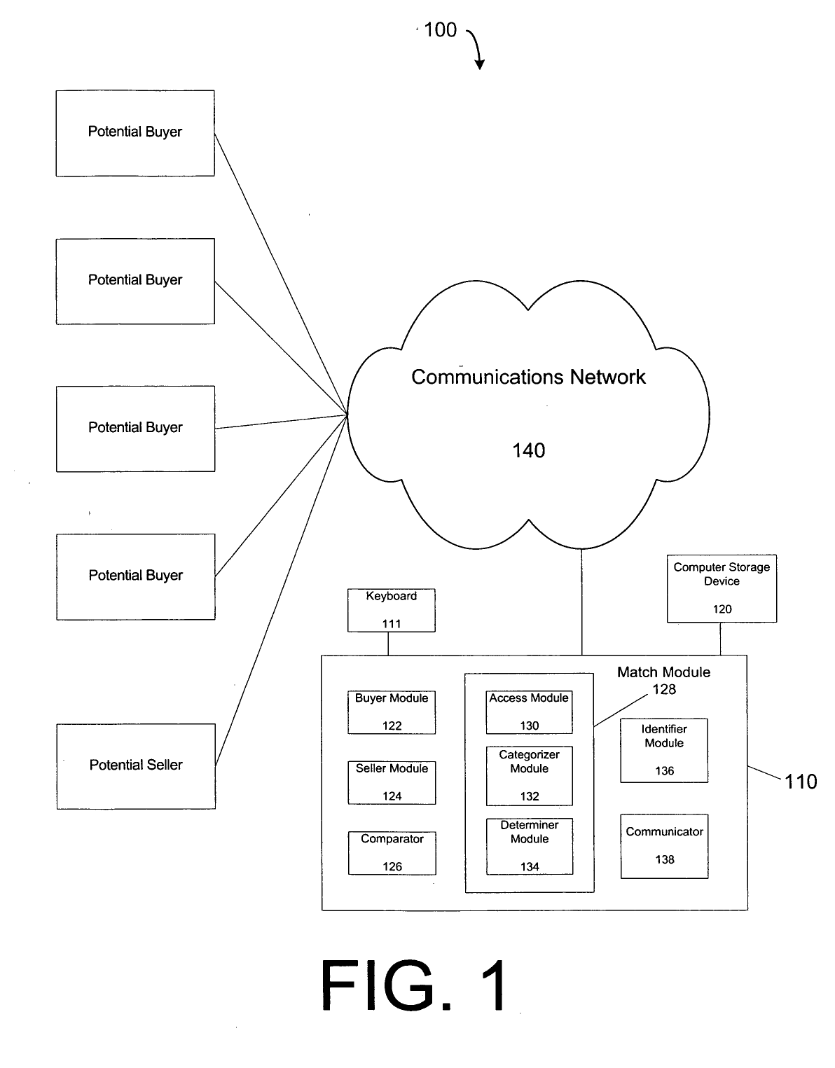

FIG. 1 shows a block diagram of a computer system 100 on which illustrative embodiments may be used. Illustrative embodiments permit users, such as potential and actual buyers and potential and actual sellers of real estate, to bypass traditional methods of selling real estate. Consequently, costs associated with such transactions, such as sizable real estate commissions, are saved. The system 100 includes a server 110 coupled to a communications network 140, through which users are able to communicate with the system 100.

In illustrative embodiments, the server 110 is a secure server that permits access to authorized users only and analyzes the real estate information received from users. The system 110 includes a buyer module 122 and a seller module 124 for receiving real estate information, via the communications network 140, from potential buyers and potential sellers, respectively. When the buyer module 122 receives information from potential buyers, it may index the information for storage in a database. This allows the system 110 to more quickly and easily access information received from buyers. The server 110 also includes a comparator 126 and a match module 128, both of which perform the analysis.

More specifically, the comparator 126 and components of the match module 128 determine if information the system 100 receives from a potential seller matches information the system 100 has previously collected from at least one potential buyer. Within the match module 128, an access module 130 is capable of retrieving the database of indexed information received from potential buyers. The indexed information has already been divided by the system 100 into at least one category. The match module 130 also includes a categorizer module 132. When the system 100 receives information from a seller, it is sent to the categorizer module 132 to be separated into at least one category. The determiner module 134 uses the categorized information from both the access module 130 and the categorizer module 132 to compare like categories to determine if there is a match.

If there is a match between like categories, the system 100 requests that an identifier module 136 to notify the potential seller of the match via the communications network 140. The system 100 also makes a communicator available to the potential seller, via the communications network 140, so that the potential seller may contact any potential buyers whose information the system 100 found to match the information of the potential seller.

The communications network 140 of the system 100 may be, for example but not limited to, the Internet, a local area network (LAN), a broadband network such as DSL or cable, a wireless network such as WiFi, or any other communications network that is capable of transmitting and receiving data. Users may transmit information by using any device that is capable of transmitting and receiving data, such as a personal computer, a personal data assistant, a cellular phone, or any other device that can communicate with the server 110 through the communications network 140. Users may also provide information through non-electronic means, such as writing the information on paper and mailing the paper to the operator of the system 100. The information will then be directly entered into the server 110, by using, for example, a keyboard 111.

Any information received by the server 110 over the communications network 140 may then be stored on a computer storage device 120. The computer storage device 120 may or may not be part of the server 110. A computer storage device includes, but is not limited to, a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or any other tangible storage medium. The information may be stored indefinitely, or for a set period of time, such as for ninety days. Users of the system 100 are able to access and view any information stored on the computer storage device 120 in any conventional manner, such as by using a computer with web browsing software that is coupled to the communications network 140.

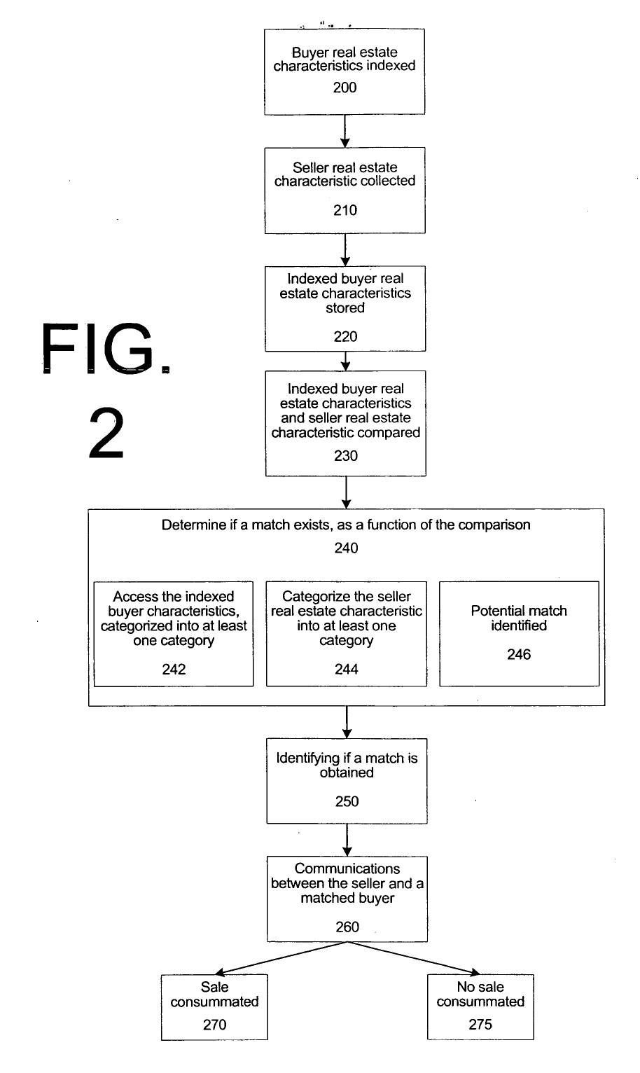

FIG. 2 shows a method used by the system 100 for analyzing real estate data in accordance with illustrative embodiments of the invention. The method allows a plurality of potential buyers of real estate to generate buyer real estate characteristics, and provide these to, for example, a computer system such as the system 100 described in connection with FIG. 1. Among others, a potential buyer may be an individual, a corporate unit, a partnership, and a sole proprietorship, or an agent acting on behalf of any of these, who may be interested in purchasing a unit of real estate. A potential buyer may include an actual buyer. Buyer real estate characteristics may include any information, provided by the potential buyer, with regard to real estate that the potential buyer may desire to purchase. The buyer real estate characteristics may include, but are not limited to, any of the following:

the location of the real estate,

type of real estate; number of rooms,

number of bedrooms,

number of bathrooms,

square footage,

the age of any structures on the real estate,

features of the structures on the land, such as a basement, a laundry room and or equipment, a fireplace or fireplaces, hardwood floors, carpeted floors, an office, a den, central air, a central vacuum, disability features, a family room, a spa, a hot tub, a JACUZZI, a bedroom on a particular floor, a bathroom on a particular floor, a swimming pool, a garage or other parking facilities,

whether pets and or animals are allowed,

price information,

school district, and

any other information concerning the real estate that any potential buyer desires to provide.

The location of the real estate may be identified broadly, for example, by indicating a state or a province. Alternatively, the location may be identified more narrowly, for example, by name of a city, town, village, or hamlet within a particular state or province.

In step 200, the buyer real estate characteristics provided by a potential buyer are indexed. For example, if the potential buyer discloses that he might like to purchase a residential home in Sharon, Mass. with 3 bedrooms and 1.5 bathrooms for $350,000, this information is indexed in a database. Before a potential buyer provides buyer real estate characteristics, however, illustrative embodiments require that the potential buyer register with the service. To register, the potential buyer provides contact information, and chooses an access id and password. In alternative embodiments, however, no registration is required.

In the second step 210, at least one seller real estate characteristic is collected from a potential seller. Among others, a potential seller may be an individual, any corporate unit, a partnership, and a sole proprietorship, or an agent acting on behalf of any of these, who may be interested in selling a unit of real estate. A potential seller may include an actual seller. Of course, multiple real estate characteristics may be collected from the potential seller. The seller real estate characteristics are generated by a potential seller of real estate, and describe the real-estate with as much detail as the seller wishes to disclose. The seller real estate characteristics may include any of the same details as the buyer real estate characteristics. The potential seller may access and view the listed indexed buyer real estate characteristics at any time.

After being indexed, the buyer real estate characteristics may also be stored in any type of computer storage device, as shown in step 220. Such a computer storage device may include a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or any other tangible storage medium. Embodiments also may store the seller real estate characteristics as well.

In the next step of the process, step 230, the indexed buyer real estate characteristics and the at least one seller real estate characteristic are compared. The comparison may occur, for example, because the potential seller desires to know if there are any potential buyers who have generated buyer real estate characteristics that are interested in the real estate the potential seller may offer for sale. An advantage of the method is that the potential seller is not limited to accessing and viewing the listed indexed buyer real estate characteristics of one potential buyer only. Rather, the potential seller may access and view the buyer real estate characteristics provided by a plurality of potential buyers. To begin the comparison, for example, the potential seller initiates a search.

In step 240, it is determined if there is a match between at characteristics of at least one of the potential buyers and the potential seller. To determine if there is a match, the indexed buyer real estate characteristics are accessed, in step 242. When accessed, the indexed buyer real estate characteristics have been categorized into at least one category. The categories may include broad categories, such as descriptions of the real estate or descriptions of structures on the real estate, or more narrow categories, such as the different types of buyer real estate characteristics a buyer or potential buyer may generate. The at least one seller real estate characteristic is also categorized into at least one category, in step 244. Like categories of indexed buyer real estate characteristics are then-compared with seller real estate characteristics to determine if there is a match. If a match is obtained, it is identified (step 250). If multiple matches are obtained, then each match is identified.

If there is a match, the potential seller can decide whether or not to communicate with the potential buyer. In illustrative embodiments, before contact can occur, the potential seller registers by providing contact information and selecting an access id and password. If the potential seller has already registered, prior to the comparison occurring, the potential seller may initiate communication with the potential buyer (step 260). At least the first communication is substantially identity anonymous, such that neither the potential buyer nor the potential seller is aware of the identity of the other party. Successive communications between the parties may continue to be identity anonymous at the discretion of the parties. Of course, in other embodiments, the first communication identifies the parties.

After the initial communication, either party may choose to reveal their identity to the other. During the communications, the seller and buyer may attempt to negotiate a sale of the real estate. The on-going communications ultimately result in a sale being consummated (step 270) or no sale being consummated (275).

It should be noted that the terms “server” and “secure server” are used herein to describe a communication device that may be used in a communication system, unless the context otherwise requires, and should not be construed to limit the present invention to any particular communication device type. Thus, a communication device may include, without limitation, a bridge, router, bridge-router (brouter), switch, node, or other communication device, which may or may not be secure.

It should also be noted that the flowchart is used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality previously described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Various embodiments may be embodied in other specific forms without departing from the true scope of the invention. The described embodiments are to be considered in all respects as illustrative only and not restrictive.

What is claimed is:

1. A method of analyzing real estate information relating to a plurality of potential buyers and a potential seller, the method comprising:
indexing buyer real estate characteristics generated by the plurality of potential buyers;
collecting at least one seller real estate characteristic generated by the potential seller;
comparing the indexed buyer real estate characteristics and the at least one seller real estate characteristic; and
determining if there is a match between at least one of the potential buyers and the potential seller, determining being a function of the comparison.

2. The method as defined by claim 1 further comprising identifying whether a match is obtained.

3. The method as defined by claim 1 wherein determining comprises:
accessing the indexed buyer real estate characteristics, the indexed buyer real estate characteristics being categorized into at least one category;
categorizing the at least one seller real estate characteristic into at least one category; and
comparing like categories of indexed buyer real estate characteristics with seller real estate characteristics.

4. The method as defined by claim 3 wherein the at least one category includes location.

5. The method as defined by claim 1 further comprising storing the indexed buyer real estate characteristics in a computer storage device.

6. The method as defined by claim 1 further comprising communicating between the potential seller and at least one of the potential buyers, communicating being substantially identity anonymous for at least one communication.

7. The method as defined by claim 1 wherein at least one of the potential buyers includes a buyer agent.

8. The method as defined by claim 1 wherein the potential seller includes a seller agent.

9. An apparatus for analyzing real estate information relating to a plurality of potential buyers and a potential seller, the apparatus comprising:
a buyer module capable of indexing buyer real estate characteristics generated by the plurality of potential buyers;
a seller module capable of collecting at least one seller real estate characteristic generated by the potential seller;
a comparator capable of comparing the indexed buyer real estate characteristics and the at least one seller real estate characteristics; and
a match module capable of determining if there is a match between at least one of the potential buyers and the potential seller, determining being a function of the comparison.

10. The apparatus as defined by claim 9 further comprising an identifier module capable of identifying whether a match is obtained.

11. The apparatus as defined by claim 9 wherein the match module comprises:
an access module capable of accessing the indexed buyer real estate characteristics, the indexed buyer real estate characteristics being categorized into at least one category;
a categorizer module capable of categorizing the at least one seller real estate characteristic into at least one category; and
a determiner module capable of comparing like categories of indexed buyer real estate characteristics with seller real estate characteristics.

12. The apparatus as defined by claim 11 wherein the at least one category includes location.

13. The apparatus as defined by claim 9 further comprising a storage module capable of storing the indexed buyer real estate characteristics in a computer storage device.

14. The apparatus as defined by claim 9 further comprising a communicator capable of communicating between the potential seller and at least one of the potential buyers, communicating being substantially identity anonymous for at least one communication.

15. The apparatus as defined by claim 9 wherein at least one of the potential buyers includes a buyer agent.

16. The apparatus as defined by claim 9 wherein the potential seller includes a seller agent.

17. A computer program product for use on a computer system for analyzing real estate information relating to a plurality of potential buyers and a potential seller, the computer program product comprising a computer usable medium having computer readable program code thereon, the computer readable program code comprising:
program code for indexing buyer real estate characteristics generated by the plurality of potential buyers;
program code for collecting at least one seller real estate characteristic generated by the potential seller;
program code for comparing the indexed buyer real estate characteristics and the at least one seller real estate characteristics; and
program code for determining if there is a match between at least one of the potential buyers and the potential seller, determining being a function of the comparison.

18. The computer program product as defined by claim 17 further comprising program code for identifying whether a match is obtained.

19. The computer program product as defined by claim 17 wherein the program code for determining comprises:
program code for accessing the indexed buyer real estate characteristics, the indexed buyer real estate characteristics being categorized into at least one category;
program code for categorizing the at least one seller real estate characteristic into at least one category; and
program code for comparing like categories of indexed buyer real estate characteristics with seller real estate characteristics.

20. The computer program product as defined by claim 19 wherein the at least one category includes location.

21. The computer program product as defined by claim 17 further comprising program code for storing the indexed buyer real estate characteristics in a computer storage device.

22. The computer program product as defined by claim 17 further comprising program code for communicating between the potential seller and at least one of the potential buyers, communicating being substantially identity anonymous for at least one communication.

23. The computer program product as defined by claim 17 wherein at least one of the potential buyers includes a buyer agent.

24. The computer program product as defined by claim 17 wherein the potential seller includes a seller agent.
